(19) United States
(12) Patent Application Publication
(10) Pub. No.: US 2020/0258045 A1
(43) Pub. Date: Aug. 13, 2020

(54) SYSTEM AND METHOD FOR ASSESSING SKILL AND TRAIT LEVELS

(71) Applicant: MISELLF INC., Oakville (CA)

(72) Inventor: James Francis KNUPFER, Oakville (CA)

(21) Appl. No.: 16/274,980

(22) Filed: Feb. 13, 2019

(51) Int. Cl. G06Q 10/10

(52) U.S. Cl. CPC G06Q 10/1053

(57) ABSTRACT

A computer system is provided having at least one processor, a storage storing a set of challenges, each of the challenges being identified as associated with at least one of a set of skills and having an associated skill level, and a set of computer-executable instructions that, when executed, cause the computer system to repeatedly: select, for presentation, one of the set of challenges tagged with a selected one of the set of skills for which an identifier has been received at least partially based on a user skill level maintained for a user profile; receive response input for the one of the set of challenges; track and register user interaction events with the client application; and update the user skill level for the selected one of the set of skills and at least one user trait level for the response input and the user interaction events.

### FIELD

The specification relates generally to assessment systems. In particular, the following relates to a computer system and method for assessing skill and trait levels.

### BACKGROUND OF THE DISCLOSURE

Recruitment has evolved over the years. An employer identifies a need for one or more workers, determines a scope for each position, and uses various approaches to find suitable candidates. These approaches can include the posting of the positions, externally and/or internally, the engagement of one or more recruitment agencies, and reviewing previously received applications. This process of finding candidates with the appropriate skill levels can be cumbersome, resource-intensive, slow, and expensive. This is especially true in fields where labor shortages have made finding suitably skilled candidates more difficult.

The review of applications can take considerable time and can provide poor information. First, the applications must be reviewed and filtered. Applicants, however, may intentionally or unintentionally mischaracterize their skill levels and history. Skill levels may be overstated or even understated or omitted. Further, the applications may be outdated in that they do not accurately characterize the current skill levels of the applicants. Still further, an applicant's skill levels and even skills may not match their current or prior positions, making it difficult to judge their competency.

Once the applications are filtered, applicants may be interviewed and subsequently tested. This testing provides a snapshot of the applicants' skill levels, but, as can be appreciated, is expensive and time-consuming to administer. Further, if references are consulted regarding the skill levels of the applicants, subjective bias can color the information received from the references. Where an internal candidate is applying, the assessment of their skill levels by their manager may be inaccurate.

The assessment of behavioral traits of applicants is, in many cases, more challenging. Different positions can have different requirements, not just technically, but also personality-wise. Where the employer is looking for a worker to integrate into a larger team, teamwork can often be more desirable. In scenarios where the employer is looking for a worker for a small team or who will work alone, teamwork may be less important, and independence can be more desirable. The assessment of the behavioral traits of applicants can be difficult to assess, as little information is available to the employer. While internal and external references can provide some insight into how the applicant works, this information is subjective. Further, the employer may only have a short period of time to spend with an applicant before having to make a decision as to whether they possess appropriate behavioral traits for the position.

If recruitment agencies are employed, fees typically in the range from 15% to 25% of the worker's annual salary become payable.

This entire process generally takes a minimum of one month to find applicants with the requisite skill levels and the desired behavioral traits, and more typically three months or more to have a worker start at a position. In cases where the positions are short-term, this process can be reduced, but the investment required can be even then more significant in relation to the work to be performed.

It can be difficult to objectively locate the best candidates for a position. With the trend of globalization and working remotely, many markets are moving from roles based to skills based, thereby reducing the effectiveness of traditional recruitment processes. Further, due to the rapidly changing demands in certain markets, such as technology, media, and communications, there can be significant lost revenue due to skills shortages and/or the delay in filling a position.

### SUMMARY OF THE DISCLOSURE

In one aspect, there is provided a computer system for assessing skill and trait levels, comprising: at least one processor; a storage storing a set of challenges, each of the challenges being tagged with at least one of a set of skills and an associated level, and a set of computer-executable instructions that, when executed by the at least one processor, cause the computer system to repeatedly: select, for presentation via a client application, one of the set of challenges tagged with a selected one of the set of skills for which an identifier has been received at least partially based on a user skill level maintained for a user profile; receive response input for the one of the set of challenges; track and register user interaction events with the client application; and update the user skill level maintained for the user profile for the selected one of the set of skills and at least one user trait level maintained for the user profile for the response input and the user interaction events.

The updating of the at least one user trait level maintained for the user profile can be performed using artificial intelligence.

The computer system can generate a score for the response input for the one of the set of challenges for the user profile, and the user skill level for the selected one of the set of skills can be adjusted at least partially based on the score for the response input.

The computer system can register the user skill level with previously registered user skill levels maintained for the user profile.

The computer system can register the at least one user trait level with previously registered user trait levels maintained for the user profile.

The selected one of the set of challenges can be tagged with another of the set of skills, and the computer system can update the user skill level maintained for the user profile for the other of the set of skills for the response input.

The user interaction events can include requests for assistance, messaging events, a loss of focus of the client application, and a presentation of the selected one of the set of challenges and the receipt of response input for the selected one of the set of challenges.

The computer system can receive revised response input for the selected one of the set of challenges, and can update the user skill level maintained for the user profile for the selected one of the set of skills and at least one user trait level maintained for the user profile for the revised response input and the user interaction events.

The computer system can generate at least one confidence level for the user skill levels maintained for the user profile. The computer system confidence level can be at least partially based on the user interaction events.

In accordance with another aspect, there is provided a method for assessing skill and trait levels, comprising: selecting, for presentation via a client application, one of a set of challenges stored in storage of a computer system and tagged with a selected one of a set of skills for which an identifier has been received by the computer system and an associated skill level, the one of the set of challenges being selected at least partially based on a user skill level maintained for a user profile; receiving response input via the computer system for the one of the set of challenges; tracking and registering user interaction events with the client application; and updating the user skill level maintained for the user profile for the selected one of the set of skills and at least one user trait level maintained for the user profile for the response input and the user interaction events.

The updating of the at least one user trait level maintained for the user profile can be performed via artificial intelligence.

The method can further comprise generating a score for the response input for the one of the set of challenges for the user profile, and the user skill level for the selected one of the set of skills can be adjusted at least partially based on the score for the response input.

The method can further comprise registering the updated user skill level with previously registered user skill levels maintained for the user profile.

The method can further comprise registering the at least one updated user trait level with previously registered user trait levels maintained for the user profile.

The selected one of the set of challenges can be tagged with another of the set of skills, and the method can further comprise updating of the user skill level maintained for the user profile for the other of the set of skills for the response input.

The user interaction events can comprise requests for assistance, messaging events, a loss of focus of the client application, and a presentation of the selected one of the set of challenges and the receipt of response input for the selected one of the set of challenges.

The method can further comprise, upon receiving revised response input for the selected one of the set of challenges, updating the user skill level maintained for the user profile for the selected one of the set of skills and at least one user trait level maintained for the user profile for the revised response input and the user interaction events.

The method can further comprise generating at least one confidence level for the user skill levels maintained for the user profile. The confidence level can be at least partially based on the user interaction events.

### BRIEF DESCRIPTIONS OF THE DRAWINGS

For a better understanding of the various embodiments described herein and to show more clearly how they may be carried into effect, reference will now be made, by way of example only, to the accompanying drawings in which:

FIG. 1 shows a computer system for assessing skill and trait levels and its operating environment in accordance with one embodiment thereof;

FIG. 2 is a schematic diagram showing various physical and logical components of the computer system of FIG. 1; and

FIG. 3 is a schematic diagram showing the main software components of the computer system and a client computing device of FIG. 1;

FIG. 4 shows various data structures that are maintained by the computer system of FIG. 1;

FIG. 5 shows the general method of using the computer system of FIG. 1;

FIG. 6 shows a client application screen presented by the client application of FIG. 3 during user profile setup;

FIG. 7 shows the process of assessing a user skill and trait levels of the method of FIG. 5 in greater detail;

FIG. 8 shows a client application screen presenting a challenge with simple multiple choice answers;

FIG. 9 shows a screen of the client application of FIG. 3 presenting a challenge with more complex multiple choice answers;

FIG. 10 shows the client application screen of FIG. 9 showing programming code for one of the choices;

FIG. 11 shows the client application screen of FIG. 9 upon selection of one of the multiple choice answers;

FIG. 12 shows the method of updating user skill and trait levels used by the computer system of FIG. 1;

FIGS. 13A and 13B illustrate a screen presented by the client application of FIG. 3 showing a user skill summary;

FIG. 14 illustrates a screen presented by the client application of FIG. 3 showing an employer summary;

FIGS. 15A and 15B illustrate a screen presented by the client application of FIG. 3 for locating candidates;

FIG. 16 illustrates a screen presented by the client application of FIG. 3 of candidates matching specified search criteria;

FIGS. 17A and 17B illustrate a screen presented by the client application of FIG. 3 summarizing a selected candidate's skills and traits; and

FIG. 18 illustrates a screen presented by the client application of FIG. 3 showing position vacancies by geographic region.

### DETAILED DESCRIPTION

For simplicity and clarity of illustration, where considered appropriate, reference numerals may be repeated among the Figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description.

Any module, unit, component, server, computer, terminal, engine or device exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the device or accessible or connectable thereto. Further, unless the context clearly indicates otherwise, any processor or controller set out herein may be implemented as a singular processor or as a plurality of processors. The plurality of processors may be arrayed or distributed, and any processing function referred to herein may be carried out by one or by a plurality of processors, even though a single processor may be exemplified. Any method, application or module herein described may be implemented using computer readable/executable instructions that may be stored or otherwise held by such computer readable media and executed by the one or more processors.

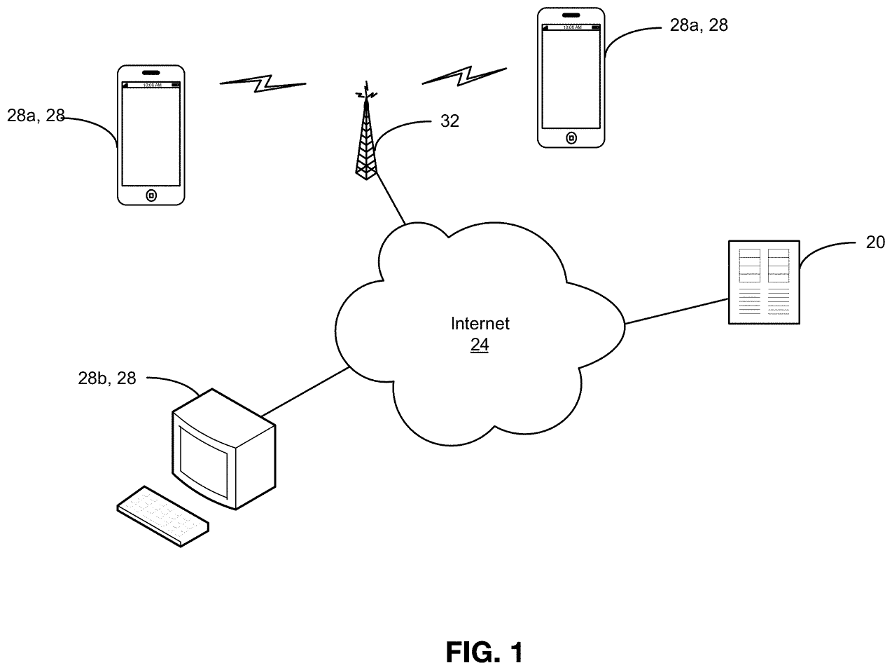

A computer system 20 for assessing skill and trait levels in accordance with an embodiment and its operating environment are shown in FIG. 1. In this embodiment, the computer system 20 is a server, but can be a set of servers that are co-located, distributed geographically or topographically, etc. and provide the same functionality. The computer system 20 is coupled to a computer communications network, which can be a public or private network. In the illustrated embodiment, the computer communications network is the Internet 24. A set of client computing devices 28 is shown in communication with the Internet 24. In particular, the client computing devices 24 shown are smartphones 28a that communicate with the Internet 24 via cellular infrastructure 32 and a desktop computer 28b, but can also be any other computing devices that can communicate with the computer system 20 over the Internet 24, such as laptop computers, tablet computers, smart televisions, etc.

The computer system 20 uses artificial intelligence to track technical knowledge expressed by their responses to challenges as well as interactions that a user has with a client application. All of this information is used to develop a holistic profile of users. The data is collected from each of the users over time to provide a longitudinal study of the user using many thousands of data points/events to build a complete profile of the user with a higher degree of accuracy than otherwise possible. Further, the user retains control of how their data is shared to provide a high degree of security and transparency to the user.

The skills can represent any technical skills that a user can have knowledge of, and that can be tested via a type of challenge to which a response can be readily provided via a client computing device 28. In one implementation, the skills assessed are related to computer programming languages, computer and network administration, scripts, data structures, services, protocols, etc. Other technical skills that are suitable for assessment via the computer system 20 include, but are not limited to, proficiency with office applications, platforms like Sales Force or SAP, spoken languages (assessed textually and/or orally), grammar, mathematics, physics, chemistry, and biology.

The traits can represent a variety of behavioral characteristics that a user may have. For example, traits can include communication skills, teamwork, perfectionism, and focus.

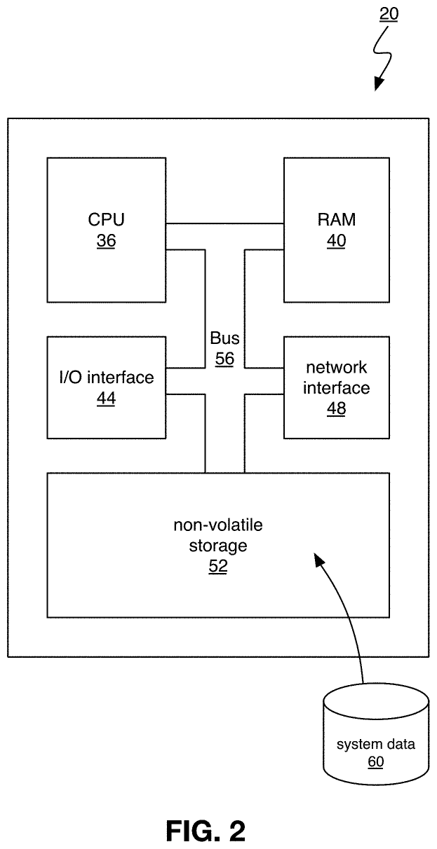

FIG. 2 shows various physical elements of the computer system 20. As shown, the computer system 20 has a number of physical and logical components, including a central processing unit (“CPU”) 36, random access memory (“RAM”) 40, an input/output (“I/O”) interface 44, a network interface 48, non-volatile storage 52, and a local bus 56 enabling CPU 36 to communicate with the other components. The RAM 40 provides relatively responsive volatile storage to the CPU 36. The I/O interface 44 allows for input to be received from one or more devices, such as a keyboard, a mouse, etc., and outputs information to output devices, such as a display and/or speakers. The network interface 48 permits communication with other computing devices, such as the client computing devices 28, over computer networks such as Internet 24. The non-volatile storage 52 stores the operating system and programs, including computer-executable instructions for implementing the skill and trait level assessment system. System data 60 is stored in the non-volatile storage 52. During operation of computer system 20, the operating system, the programs and the data may be retrieved from non-volatile storage 52 and placed in RAM 40 to facilitate execution.

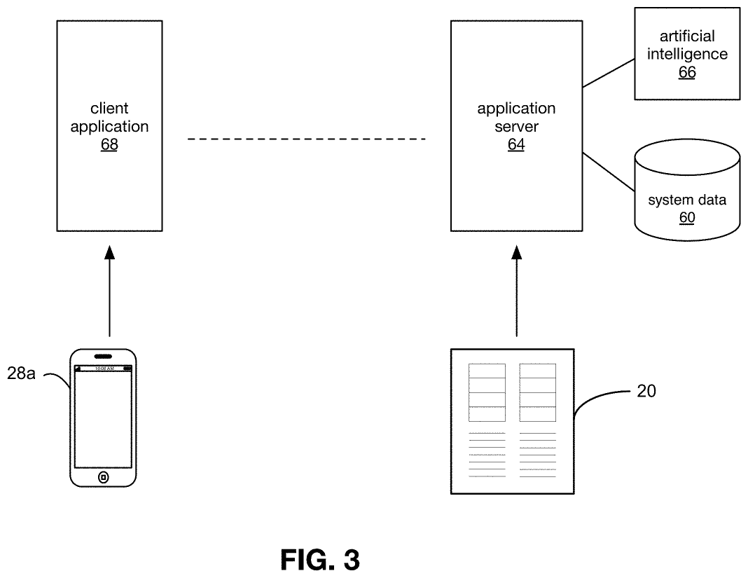

Now referring to FIGS. 1 to 3, the computer system 20 provides a skill and trait level assessment system is shown.

The skill and trait level assessment system is made accessible via an application server 64 executing on the computer system 20. The application server 64 connects to the system data 60 and provides access to the skill and trait level assessment system as a web service and/or via one or more other APIs. The application server 64 uses an artificial intelligence system 66 to process data received from the client computing device 28.

A user accesses the skill and trait level assessment system via a client application 68 on their client computing device 28. The client application can be a web application or a set of web pages presented in a web browser tab, or another app that can communicate with the application server 64. The user interaction event logs in to the skill and trait level assessment system by providing credentials via the client application 68, and then interacts with the client application 68 to establish a user profile, select skills from a list maintained by the computer system 20 for which they wish to be assessed, and then respond to challenges selected for presentation by the computer system 20. It is noted that, in some cases, two or more client application types can access the application server 64. For example, the application server 64 can be configured to communicate with different client application types, such as a web browser and a purpose-built app.

The user's skill and trait level is then assessed based on their response input, and on their interaction with the client application 68. The response input is the answer, selection, solution, etc. inputted by a user in response to a challenge. Examples of response input in this implementation include yes or no answers, selection of one (or more, where appropriate) choices, expected output based on a challenge's input, and program code to solve a problem. Where the skills are spoken languages, the challenges can be words and/or phrases to translate or respond to, and the response input can be the translated or response words and/or phrases. Further, the response data can be orally provided to assess pronunciation.

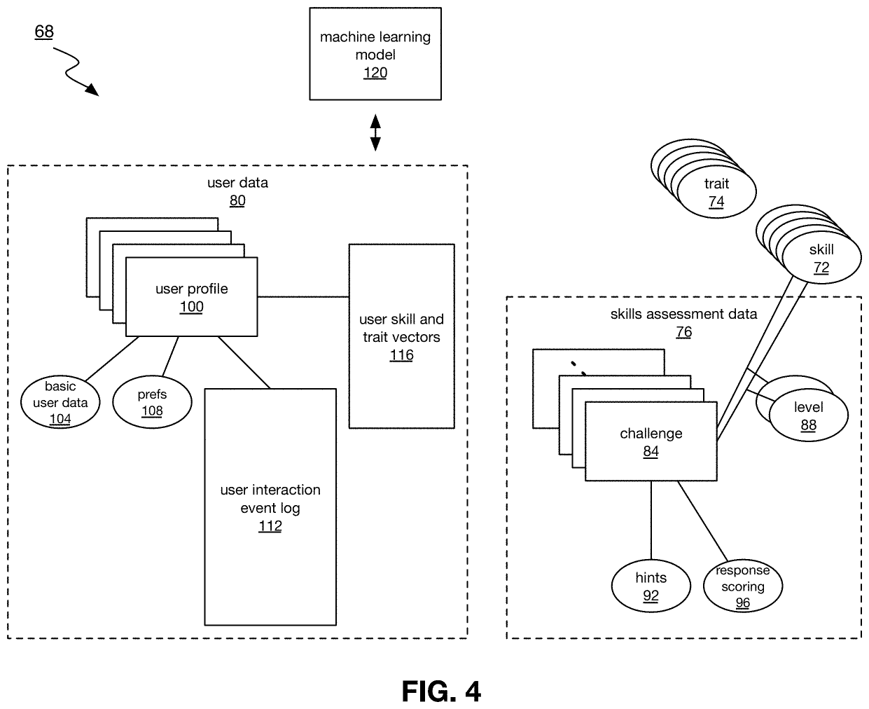

FIG. 4 shows the system data 60 maintained by the computer system 20 in the non-volatile storage 52. The system data 60 includes a set of skills 72, a set of traits 74, skills assessment data 76 that is used to assess the level of users in at least some of the skills 72, and user data 80. Each skill 72 has an associated skill identifier. Similarly, each trait 74 has an associated trait identifier.

The skills assessment data 76 includes a large set of challenges 84, each of which is tagged with one or more of the skills 72 to identify associations with certain skills 72. Challenges 84 can be tagged with multiple skills 72. For example, one challenge 84 can test both a user's HTML and CSS skills. Each challenge 84 represents a skill-testing question or problem to be responded to by users, as well as one or more satisfactory responses or outcomes. The challenges 84 can include finite solutions, such as yes or no responses or multiple choice answers, or can alternatively accept a variety of solutions that satisfactorily address the challenge 84. Each challenge 84 has a unique challenge ID.

Each challenge 84 has a level 88 for each skill 72 with which the challenge 84 is tagged. The level 88 for each skill 72 with which the challenge 84 is tagged is based on the difficulty of the challenge 84 with respect to the particular skill 72. For example, where a challenge 84 is tagged with two skills 72, the challenge 84 may require greater knowledge of a first skill 72 and lesser knowledge of a second skill 72, and thus the level for each skill 72 with which the challenge is tagged may vary. The level 88 for a skill 72 with which a challenge 84 is tagged can be discrete or continuous.

Further, one or more hints 92 can be each provided for each challenge 84. The hints 92 may be simple text messages, images, audio prompts, etc., or, alternatively, the hints 92 may be interactive.

Further, each challenge 84 can have response scoring parameters 96 that determine how the response data is scored. In some circumstances, it may be appropriate to either provide full score or no score, such as where the challenge expects a yes or no response. In other circumstances, such as where the response data is mostly correct, but has an error, or where the solution provided is less optimal, a partial score may be provided for partially correct. For example, a challenge 84 can ask a user to provide HTML code for generating a particularly formatted web page element. The challenge 84 can be tagged with two skills 72, HTML and CSS. One solution may perform the requisite function, but may be less optimal than another known approach using CSS. As a result, the response scoring 96 can indicate that the less optimal solution can give a lower score for both HTML and CSS skills 72 for the challenge 84, and that the more optimal solution can give a higher score for both HTML and CSS skills 72 for the challenge 84.

The user data 80 includes a set of user profiles 100. Each user profile 100 includes basic user data 104, such as the user's name, email address, and location. By default, the location can be determined from the IP address of the client computing device 28, but can be overwritten by the user. In addition, preferences 108 are stored for each user profile 100. These preferences can include who the user wishes to expose their data to, when to be notified, etc.

The user data 80 also includes a user interaction event log 112 of some or all of the user's interactions with the client application 68. The interaction events include, but are not limited to, the challenges 48 (via the challenge IDs) that a user has been presented with, the response input provided, and all of the interactions for how and when the user interacted with the user interface of the client application 68. This includes the keystrokes a user makes in providing a response, including deletions, touch interactions with the user interface, user interactions with chat functionality of the client application 68, either to ask for assistance or to provide assistance to others, the requesting of a hint, the losing and gaining of focus of the client application (such as via switching to another application, browser tab, etc.). These entries in the user interaction event log 112 are time-stamped.

User skill and trait vectors 116 register the user's assessed proficiency levels in the skills 72 and determined levels in the traits 74. As used herein, when “skill level” refers to a user's proficiency level in a skill 72, “skill level” and “proficiency level” may be used interchangeably. These user skill and trait vectors 116 are determined from the user interaction events that are registered in the user interaction event log 112.

Additionally, the user skill and trait vectors 116 include a response vector that acts as a counter for the number of challenges tagged with each skill that the user has answered. Thus, if a user has provided response input to 103 challenges tagged with the JavaScript skill, 42 challenges tagged with the web security skill, and 26 challenges tagged with both the JavaScript and web security skills, the JavaScript and web security skills elements in the response vector will be 129 and 68 respectively. The response vector is used by the application server 64 to determine a confidence level for the user's skill levels in each skill.

Still further, the user skill and vector traits 116 include weight vectors that represents the amount of user interaction event data that each user skill vector is generated from. The user skill and trait vectors 116 are keyed to the skill identifiers of the skills 72 and the trait identifiers of the traits 74.

A machine learning model 120 is used by the artificial intelligence system 66 to draw conclusions from the user interaction events. The machine learning model 120 is generated using training data. Using the machine learning model 120, the artificial intelligence system 66 processes the user interaction events in order to assess a user's proficiency levels in skills and their trait levels based on the user interaction events; that is, to generate the user skill and trait vectors 116.

While, in the illustrated data model, only the top-most challenge 84 is shown being tagged with associated skills 72, and having hints 92 and response scoring parameters 96, and while only the top-most user profile 100 is shown having basic user data 104, preferences 108, an associated user interaction event log 112, and user skill and trait vectors 116, it should be understood that the top-most challenge 84 and user profile 100 are representative of all challenges 84 and user profiles 100 respectively.

The general method 200 of using the skill and trait level assessment system implemented by the computer system 20 will now be described with reference to FIGS. 1 to 5. The method 200 commences with the set up of a user profile 100 for the user (210). The user can either use the client application 68 or a webpage served by the application server 64 to create a user profile 100. The user profile 100 includes basic user data 104 such as the user's name, email address, and location.

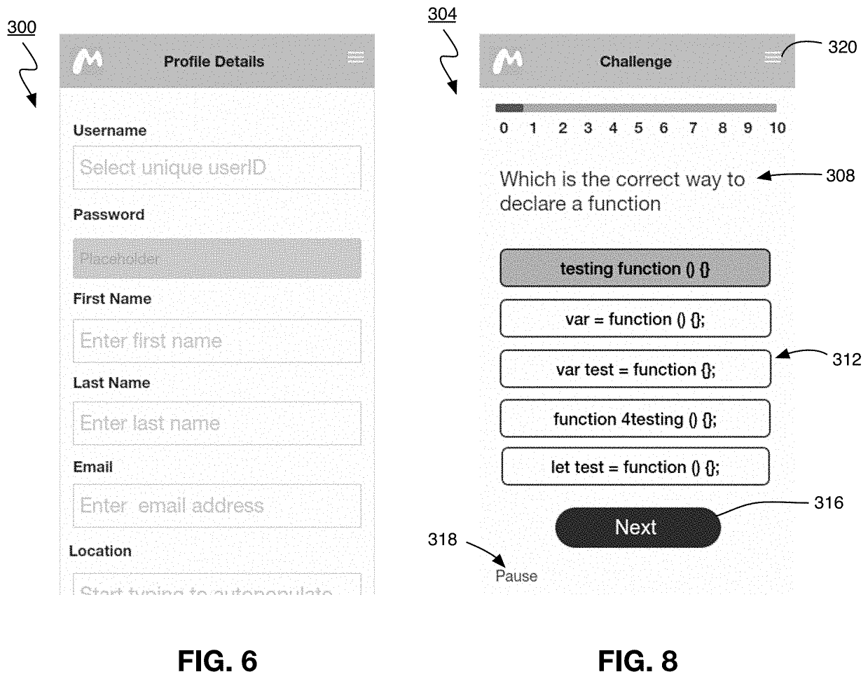

FIG. 6 shows a client application screen presented by the client application 68 during user profile setup. The client application 68 enables a user to enter basic information, such as a username, a password, their surname and given names, a location, etc. This information is stored in the basic user data 104.

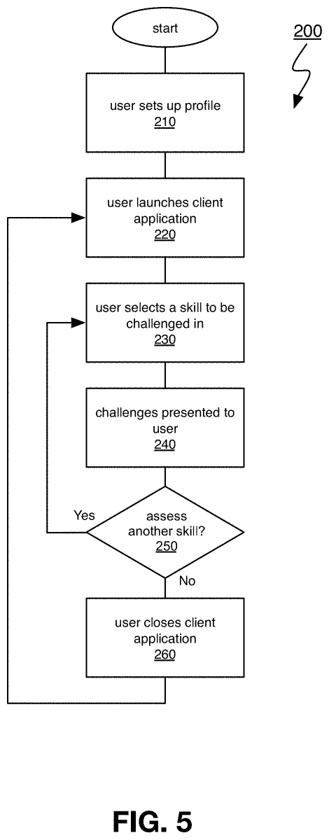

Referring again to FIG. 5, the user then launches the client application 68 (220). Once the user has registered a user profile with the computer system 20, the user can then launch the client application 68 on their client computing device 28 that then connects to the application server 64 executing on the computer system 20. The client application 68 can be, for example, a web page/application retrieved from the application server 68, a custom application, and can even in some cases be a telephony application whereby the user interacts with the application server 68 via voice. It will be understood that, if the user has immediately previously set up their user profile, they may not need to separately launch the client application 68 at 220.

Once the client application 68 is opened on the client computing device 28, the user can select one of the skills 72 offered by the computer system 20 to be assessed in (230). The user can select to be assessed in a skill 72 previously selected by the user, or can select to be assessed in a new skill 72.

Upon selecting a skill for assessment, the application server 64 begins to select and present challenges 84 to the user via the client application 68 (240).

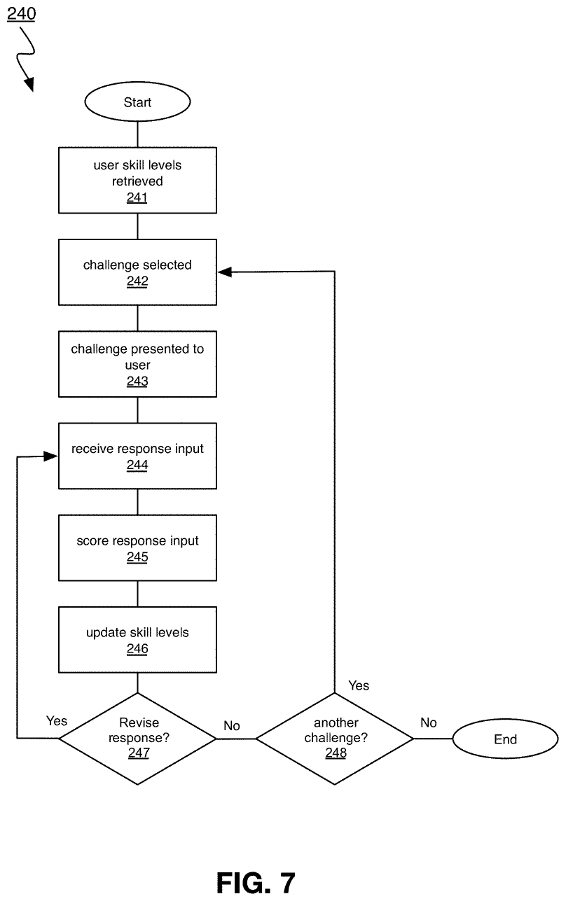

FIG. 7 shows the process 240 of selecting and presenting challenges 84 to a user in greater detail. Upon selection by the user of a skill 72 to be assessed in, the application server 64 retrieves the user skill levels (241). The application server 64 accesses the user skill and trait vectors 116 to retrieve all of the user's skill levels. If the user's proficiency level a skill 72 has not previously been assessed, the user proficiency level for that skill 72 is set to an initial level.

Using the user skill levels, a challenge 84 is selected (242). A challenge 84 is selected based on the user skill level for the selected skill 72 and the level 88 for the selected skill 72 of the challenges 84. In addition, where a challenge 84 is tagged with other skills 72, the selection of the challenge 84 may also consider the user's skill level in the other skills 72 and the level of the challenge 84 in relation to the other tagged skills 72. In this embodiment, the application server 64 selects a range for each skill 72 based on the user skill levels for each skill 72. For example, if a user has a particular skill level for a skill 72, the range may be from 80% to 120% of the user's skill level for the skill 72. The application server 64 then locates challenges 84 with levels 88 that fall in these ranges for the user. Challenges 84 that have been presented to the user within a set time period, such as the last six months, are then eliminated. The application server 64 then selects one of the challenges 84 satisfying these criteria.

The challenge 84 is then presented to the user (243). Once the application server 64 has selected a challenge 84, the computer system 20 passes data relating to the challenge 84 to the client application 68. Where the client application 68 is a purpose-built application or a web application, the data may be retrieved via any known approach, such as AJAX calls, etc. In another example, the data may alternatively be transmitted as part of a web page. Upon receipt of the data for the challenge 84, the client application 68 presents the challenge 84 to the user. This data includes the hints 92, if any, for the challenge 84. The challenge 84 can be presented on a display of the client computing device 28, but can alternatively in some cases be presented via audio speakers of or attached to the client computing device 28.

FIG. 8 illustrates an exemplary challenge screen 304 presented by the client application 68 for a challenge 84 with simple multiple choice answers. The challenge screen 304 for the challenge 84 includes a prompt 308 explaining the challenge 84, as well as a set of response options 312. In this case, only a single response option 312 may be selected by a user as response input, but for other challenges 84, more than one response option can be selected. A response submission button 316 enables a user to submit their response input. Additionally, a pause button 318 enables pausing of the challenge 84. A chat window, hints, etc. can be accessed via a menu button 320.

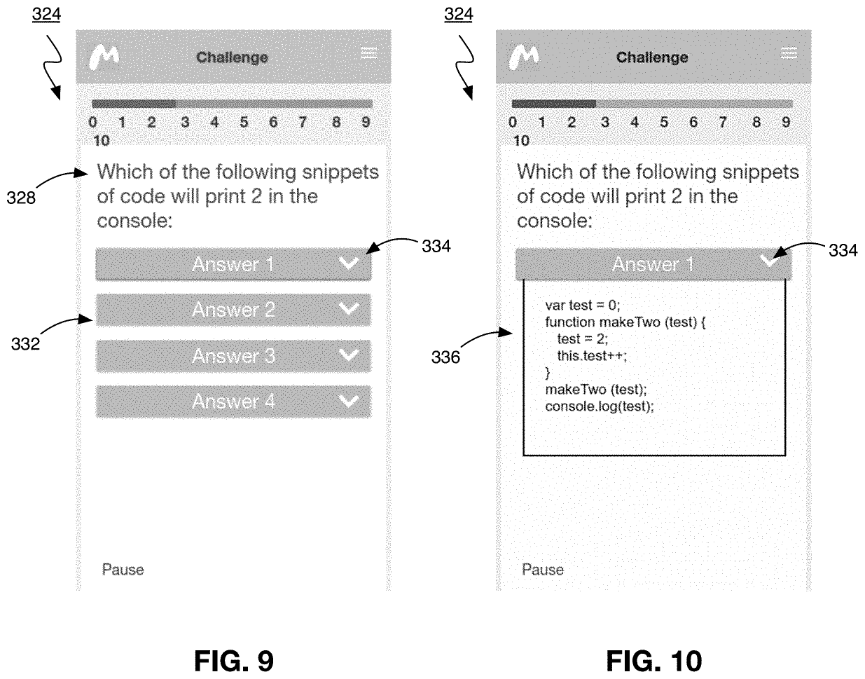

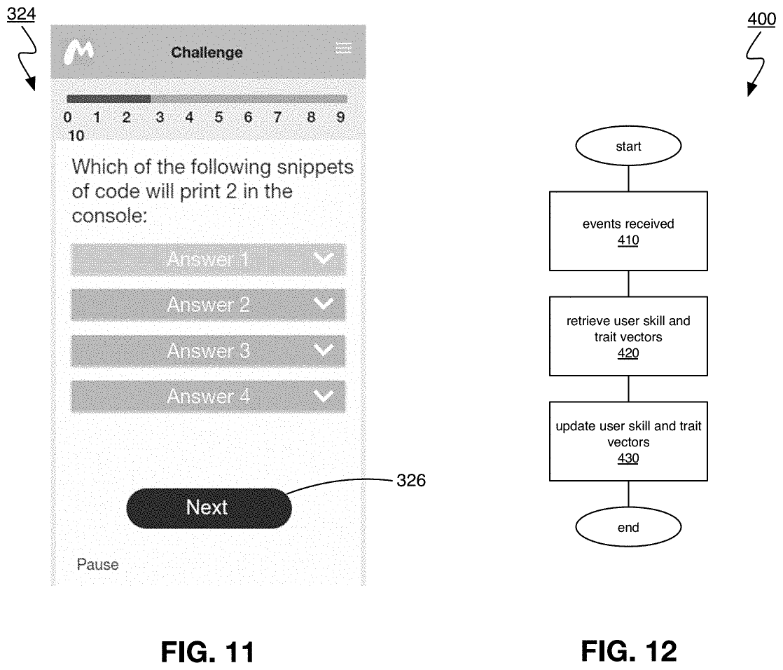

FIG. 9 illustrates another exemplary challenge screen 324 presented by the client application 68 for a challenge 84 with more complex multiple choice answers. In some scenarios, such as where the screen size of the client application 68 is limited in this illustrated example, it can be beneficial to selectively expose information-rich response options in this example. The challenge screen 324 includes a prompt 328 explaining the challenge 84, as well as a set of drop-down response options 332. Each drop-down response option 332 has a disclosure control 334. FIG. 10 shows the challenge screen 324 upon activating the disclosure control 334 of one of the drop-down response options 332. Upon activating the disclosure control 334, a response option 336 is exposed. While the response option 336 is shown as a set of programming code, it will be understood that the response options 336 can be any combination of text, images, audio signals, visual effects, etc. After review, a user can activate one of the drop-down response options 332, such as is illustrated in FIG. 11.

Returning again to FIG. 7, the client application 68 receives response input from the user (244). Response input is the data received from the user to specifically respond to the challenge 84 presented. The client application 68 provides the user a response interface for inputting response input to the challenge 84. Typically, the response interface is a text field in which text can be entered and a “submit” button to transmit the response input entered to the computer system 20. Alternatively, the response interface can be a set of buttons or controls enabling the user to select “true” or “false”, “yes” or “no”, one or more of a set of choices, etc. In this case, the response input may be deemed to be received upon selection of one of the choices, or can be registered upon activating a “submit” button or other control. In other implementations, the response interface can include an audio capture device, such as a microphone) of the client computing device 28, enabling the user to provide an oral response. Buttons or other controls can optionally be used to control audio recording, or algorithms can be used to detect when the user is providing an oral response and when the user has completed their response.

It will be understood that, in some cases, the response data is not deemed to have been received until the user expressly indicates that the input provided is to be submitted. If, the user is entering a response and makes edits, these edits can be registered as interaction data for the purposes of adjusting the scoring of the response input by the computer system 20.

This is the case with the challenge screen illustrated in FIG. 11. Upon selecting one of the drop-down response options 332, a response submission control 326 appears to enable the user to submit the response input.

Returning again to FIG. 7, upon receipt of the response input for a challenge 84, typically after the user selects to submit the entered input, the client application 68 transmits the response input to the application server 64 executing on the computer system 20. In turn, the application server 64 registers the response input in the user interaction event log 112.

Upon receipt of the response input, the application server 64 scores the response input (245). The response scoring parameters 96 are used by the application server 64 to determine the score for the response input equal to a value in the range from zero to one in this embodiment. In some cases, the response input is limited to a binary set of options, such as “yes” or “no”, or “true” or “false”, or selection of one or more choices, and scoring such response input is at least somewhat trivial. In other cases, the process of evaluating the response input can be more complicated. For example, the challenge 84 can ask a user to create a short program to perform a function. In this case, the evaluation of the response input can involve (a) syntax validation, (b) execution, (c) comparison of the output to expected results, and (d) determination of the efficiency of the program. For other skills, the method of scoring the response input can vary. For example, where the skill is a spoken language, the response input can be scored on its grammatical correctness, intonation, etc. Further, where a challenge 84 is tagged with more than one skill 72, the response input is scored each tagged skill 72.

The user skill levels are then updated in view of the response input score (246). In order to determine how the user skill levels are to be updated, the application server 64 determines an expected response input score based on the user's current skill levels in the user skill and trait vectors 116 and the level 88 for each tagged skill 72 for the challenge 84. A user with a skill level 120 that is higher than the level 88 of the selected challenge 84 for a particular skill 72 can be expected to do better than a user with a user skill level 120 that is lower than the level 88 of the selected challenge 84 for the particular skill 72. An example of a function to determine the expected adjusted response input score is:

60%+(user skill level 120−level 88 of the challenge 84)/50,

where the user skill level 120 and the level 88 of the challenges 84 are determined on a scale from 0 to 100.

The response input score is then compared to the expected response input score to determine how the user skill level for the particular skill 72 is to be adjusted. In the illustrated embodiment, the user skill level is adjusted as follows:

skill level=skill level+(response input score−expected response input score)×10

The application server 64 registers the updated skill levels in the user skill and trait vectors 116. In addition, the application server 64 updates the response vector in the user skill and trait vectors 116 for the skills tagged for the challenge associated for which the response was received. Further, the application server 64 registers the challenge 84 and the received response input in the user interaction event log 112.

In some cases, the skill and trait level assessment system may enable the user to revise their response. For example, where the user has inputted a number of lines of programming code, the user may select to review and revise their response input such as, for example, after consulting with others or reviewing a resource. The client application 68 may present a user interface control to enable them to remain on the same challenge and revise their response input.

If enabled, it is determined if the user selects to revise their response input (247). If the user has requested to revise their response input, the user is allowed to at 244. Upon receiving and scoring the revised response input, the application server 64 may update the skill level(s) corresponding to the challenge at 246. In the current embodiment, the application server 64 does not update the skill level corresponding to the challenge for which revised response input was received, but the user interaction events registers the user's additional interaction, such as their desire to improve their skill. In other embodiments, the application server 64 may update the user's skill level for the revised response input.

The client application 68 then determines if the user wishes to respond to another challenge (248). If the user indicates that they are interested in another challenge 84, another challenge 84 is selected for the user at 242 and presented to the user via the client application 68 thereafter. The challenge 84 selected is based on the updated user skill level. Thus, if a user continues to respond well or poorly to the challenges, the challenges 84 presented to the user will increase or decrease in difficulty. If, instead, the user indicates that they do not wish to attempt another challenge 84, the assessment of the user's skill level in the selected skill 72 ends. In this manner, the user can decide how little or how much time they wish to spend having their skill level assessed.

Returning again to FIGS. 1 to 5, once the assessment of the user skill level is performed, the client application 68 determines if the user wishes to assess their skill level in another skill 72 (250). If the user indicates that they want to further assess their skill level in another skill 72, the user selects the skill 72 to assess at 230, after which the user skill level in the selected skill 72 is assessed. If, instead, the user no longer wishes to assess their skill level in the skills 72, the user can close the client application 68 (260), after which the user may elect to recommence assessment of their skill level in the skills 72 by relaunching the client application 68 at 220.

Referring now to FIGS. 1 to 4, when the client application 68 is active, it is registering user interaction events and transmitting them to the application server 64 for processing. As previously noted, these user interaction events can include, for example, the keystrokes a user makes in providing a response, including deletions, touch interactions with the user interface, user interactions with chat functionality of the client application 68, either to ask for assistance or to provide assistance to others, the requesting of a hint, the losing and gaining of focus of the client application (such as via switching to another application, browser tab, etc.). These entries in the user interaction event log 112 are time-stamped.

Referring now to FIG. 12, the general method 400 of processing user interaction events is shown. The method 400 commences with the receipt of one or more user interaction events by the computer system 20 (410). The application server 64, upon receipt of the user interaction events from the client application 68, passes them to the artificial intelligence system 66. The artificial intelligence system 66 then retrieves the current user skill and trait vectors for the user (420).

Using the machine learning model 120, the artificial intelligence system 66 determines how to update, and updates, the trait levels for the behavioral traits. For example, if a user requests assistance from other users via a chat function of the client application 68, the artificial intelligence system 66 can update the trait level for teamwork for the user. If the user accesses resources available through the client application 68 after being presented with a challenge but before providing response input, the artificial intelligence system 66 can update the skill level of the user for the skills tagged for the challenge, as well as a trait level for resourcefulness. If the client application 68 has lost focus, such as by a user's switching to another browser tab or to another application, the artificial intelligence system 66 may update the trait level and/or the skill level to reflect a possible access to external resources by the user. These updated skill and trait levels are written to the user skill and trait vectors 116.

As will be understood, the client application 68 is continuously transmitting user interaction events to the application server 64 for processing.

The computer system 20 for assessing skill and trait levels enables users to build up an assessment of their skill and trait levels that may then be exposed to potential employers.

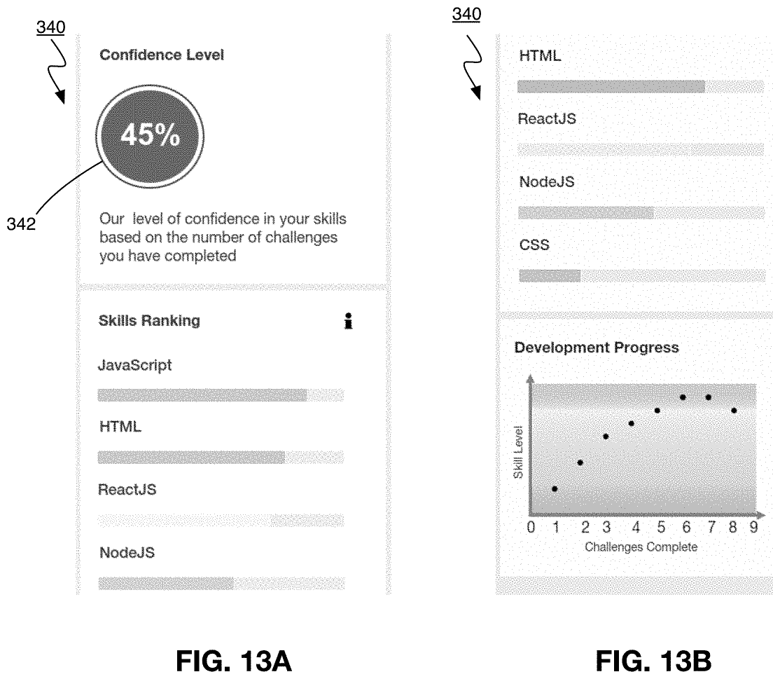

FIGS. 13A and 13B show a skill summary screen 340 generated and presented by the client application 68 to indicate the user's assessed skill levels, as well as a progress graph to give an indication of the user's progress. In addition, the skill summary screen 342 presents a confidence level 342 generated for the user's skill levels by the application server 64. The confidence level is at least partially determined using the response vector in the user skill and trait vectors 116. As the user responds to more challenges, the computer system 20 becomes more confident in the skill levels that it has calculated for the user.

In the current implementation, a unitary confidence level is determined for a user based on the total number of responses to challenges provided and on the user interaction events. If, for example, the user interaction events in the user interaction events log 112 suggest that a user takes a relatively long time to provide response, or switches to other applications or browser tabs during the process of responding to a challenge, the artificial intelligence system 66 may provide a lower confidence level in the user skill levels determined from their response input than if the user were to have provided response input more quickly or without switching applications/browser tabs. As will be appreciated, various other inferences can be drawn by the artificial intelligence system 66 from the user interaction events that cause the confidence level to be adjusted. In order for the unitary confidence level to be applied by the application server 64 to a particular skill for a user, however, the user must have answered a minimum threshold number of challenges tagged with that particular skill. In other embodiments, a separate confidence level may be determined for each skill at least partially based on the user interaction events registered during the response of a challenge tagged with that skill.

Users can select the types of positions that they are interested in being notified of. The types of positions can be specified by various criteria, including geographic location, size of the employer, the compensation level, particular companies, etc. Employers interested in hiring workers can post positions, specifying what skill proficiency and trait levels are desired for one or more positions. When positions matching a user's criteria are submitted via the position notifications, the user is notified. The user may then elect to apply or not apply for the posted position. If the user elects to apply for a position, their skill proficiency and trait levels can be exposed to the employer. Unlike the conventional hiring process, the skill proficiency and trait levels assessed for a user by the computer system 20 can be deemed a more credible assessment of the skills of the user than a resume or even the testimony of a personal reference. Users need not expose or even provide their gender, age, or employment history. Not only can the user's current proficiency levels in various skills exposed to the employer, but also various aspects of their progression stored in the user interaction event log 116 can be exposed. From this information, the employer can be enabled to determine if the user has made rapid progress in their proficiency level, is readily distracted, etc. Thus, the computer system 20 provides a more holistic skill-based and not role-based perspective of the users.

Further, as much subjectivity is removed, the cost of assessing if a user possesses the appropriate skills is significantly reduced for the employer.

Because of the objectivity of the skills proficiency level assessment provided by the computer system 20, the user proficiency level assessments can be used for other purposes, such as being provided as evidence to immigration officials that the user possesses needed skills.

The computer system 20 can also aid users in identifying areas for improvement.

Employers can also use the skill and trait level assessment system in order to locate candidates for work.

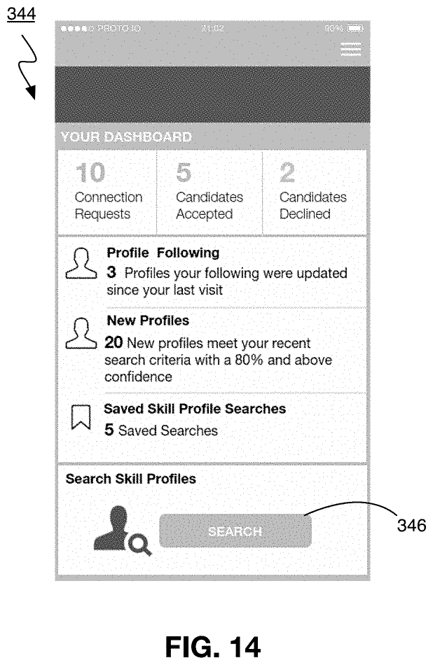

FIG. 14 illustrates an employer dashboard screen 344 presented to an employer when logged in. The employer dashboard screen indicates the number of connection requests that they've made for users, the number of users that have accepted such requests, and the number of candidates that have declined. The employer dashboard screen 344 also indicates the number of user profiles that the employer has chosen to follow, the number of new profiles that match search criteria that the employer has specified, and the number of saved candidate searches. The employer dashboard screen 344 also enables an employer to specify criteria for a new candidate search via a new search button 346.

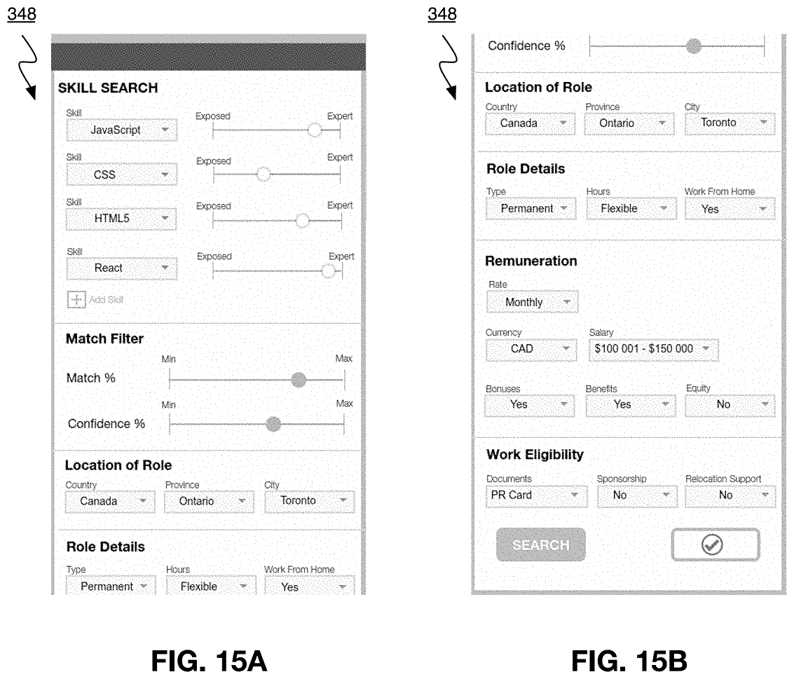

FIGS. 15A and 15B show a candidate search screen 348 triggered via activation of the new search button 346. The new search screen 348 enables the employer to specify desired skills and skill levels, how closely candidates have to match the specified criteria to be returned in the results, the confidence level desired for the users' skill levels, the location of the role, the type of role, remuneration details, and governmental work eligibility requirements.

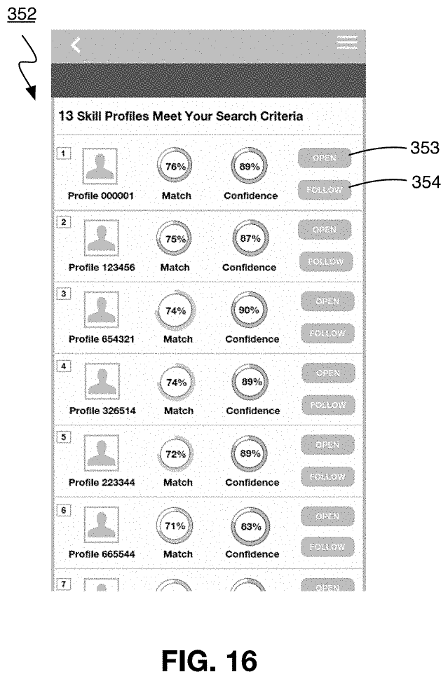

FIG. 16 shows an exemplary candidate search results screen 352 that includes a list of candidates, the percent match for each candidate to the desired skill levels, and the confidence level for the user's skill levels. If a user has not answered the minimum threshold number of challenges for a requisite skill specified in the search criteria, the user may be shown as having an indeterminate confidence level as insufficient data has been collected and thus may appear lower in the search results. This can be conveyed to the searcher via the search results interface. In other embodiments, the confidence level for the user may be reduced to reflect the at least partially insufficient data.

The search results do not include personally-identifying information, enabling the candidates to maintain anonymity. The employer can elect to view more details for a candidate via a corresponding candidate view button 353, and can select to follow the progress of the candidate via a follow button 354.

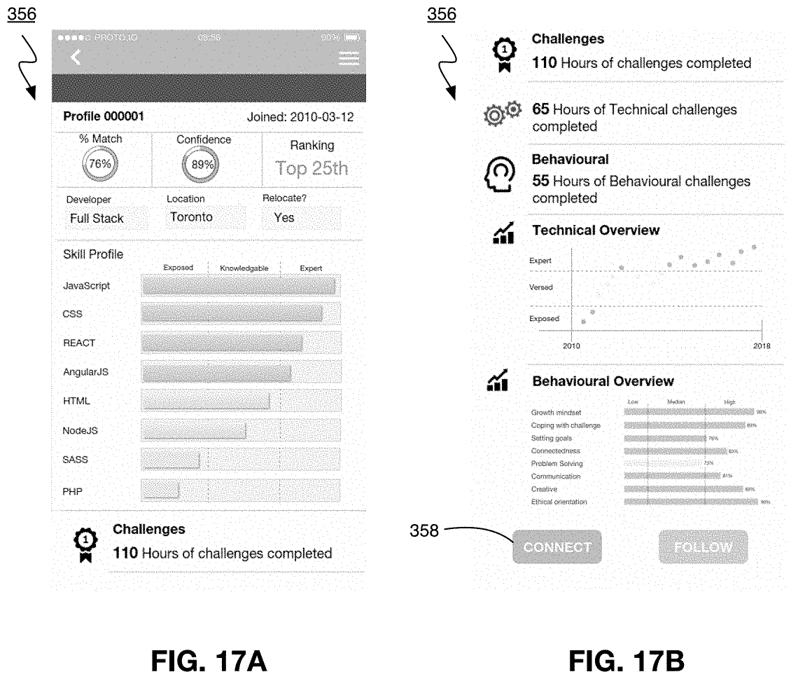

FIGS. 17A and 17B show a candidate summary screen 356 presented to an employer upon activating the candidate view button 353. The candidate summary screen 356 shows how the candidate ranks relative to other candidates, the candidate's location, whether the candidate is willing to relocate, the candidate's skill levels, the amount of time they spent answering challenges, a graph of their technical skill progression, and a behavioral overview graph illustrating some key traits of the candidate. A connect button 358 enables the employer to send a request to the candidate to open a discussion. When the candidate receives the request, the candidate can decide whether to expose more information, including contact details, name, etc., or reject the request to maintain their anonymity.

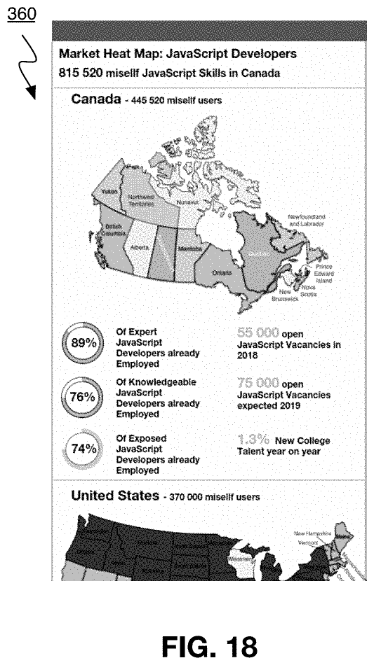

FIG. 18 shows a region summary screen 360 for JavaScript developers that can be viewed by an employer. The region summary screen 360 graphically presents an overview of the current and projected JavaScript developer markets by region.

Computer-executable instructions for implementing the method for assessing skill proficiency and trait levels on a computer system could be provided separately from the computer system, for example, on a computer-readable medium (such as, for example, an optical disk, a hard disk, a USB drive or a media card) or by making them available for downloading over a communications network, such as the Internet.

While the computer system is shown as a single physical computer, it will be appreciated that the computer system can include two or more physical computers in communication with each other. Accordingly, while the embodiment shows the various components of the computer system residing on the same physical computer, those skilled in the art will appreciate that the components can reside on separate physical computers.

Persons skilled in the art will appreciate that there are yet more alternative implementations and modifications possible, and that the above examples are only illustrations of one or more implementations. The scope, therefore, is only to be limited by the claims appended hereto.

### LIST OF REFERENCE NUMERALS

20 computer system
24 Internet
28 client computing device
28a smartphone
28b desktop computer
32 cellular infrastructure
36 CPU
40 RAM
44 I/O interface
48 network interface
52 non-volatile storage
56 local bus
60 system data
64 application server
66 artificial intelligence system
68 client application
72 skill
74 trait
76 skills assessment data
80 user data
84 challenge
88 level
92 hints
96 response scoring parameters
100 user profile
104 basic user data
108 preferences
112 user interaction event log
116 user skill and trait vectors
120 machine learning model
200 general method
210 user sets up profile
220 user launches client application
230 user selects a skill to be challenged in
240 challenges presented to user
241 user skill levels retrieved
242 challenge selected
243 challenge presented to user
244 receive response input
245 score response input
246 update skill and trait levels
247 another challenge?
250 assess another skill?
260 user closes client application
300 profile creation screen
304 challenge screen
308 challenge prompt
312 response options
316 response submission button
318 pause button
320 menu button
324 challenge screen
326 response submission control
328 challenge prompt
332 drop-down response options
334 disclosure control
336 response text
340 skills summary screen
342 confidence level
344 employer dashboard screen
346 new search button
348 candidate search screen
352 candidate search results screen
353 candidate view button
354 candidate follow button
356 candidate summary screen
358 connect button
360 region summary screen
400 method of updating user skill and trait levels
410 events received
420 retrieve user skill and trait vectors
430 update user skill and trait vectors
440 register user skill and trait vectors

1. A computer system for assessing skill and trait levels, comprising:
at least one processor;
a storage storing a set of challenges, each of the challenges being tagged with at least one of a set of skills and an associated level, and a set of computer-executable instructions that, when executed by the at least one processor, cause the computer system to repeatedly:
select, for presentation via a client application, one of the set of challenges tagged with a selected one of the set of skills for which an identifier has been received at least partially based on a user skill level maintained for a user profile;
receive response input for the one of the set of challenges;
track and register user interaction events with the client application; and
update the user skill level maintained for the user profile for the selected one of the set of skills and at least one user trait level maintained for the user profile for the response input and the user interaction events.

2. The computer system of claim 1, wherein the updating of the at least one user trait level maintained for the user profile is performed using artificial intelligence.

3. The computer system of claim 2, wherein the computer system generates a score for the response input for the one of the set of challenges for the user profile, and the user skill level for the selected one of the set of skills is adjusted at least partially based on the score for the response input.

4. The computer system of claim 2, wherein the computer system registers the user skill level with previously registered user skill levels maintained for the user profile.

5. The computer system of claim 2, wherein the computer system registers the at least one user trait level with previously registered user trait levels maintained for the user profile.

6. The computer system of claim 2, wherein the selected one of the set of challenges is tagged with another of the set of skills, and wherein the computer system updates the user skill level maintained for the user profile for the other of the set of skills for the response input.

7. The computer system of claim 2, wherein the user interaction events comprise requests for assistance.

8. The computer system of claim 2, wherein the user interaction events comprise messaging events.

9. The computer system of claim 2, wherein the user interaction events comprise a loss of focus of the client application.

10. The computer system of claim 2, wherein the user interaction events comprise a presentation of the selected one of the set of challenges and the receipt of response input for the selected one of the set of challenges.

11. The computer system of claim 2, wherein the computer system receives revised response input for the selected one of the set of challenges, and updates the user skill level maintained for the user profile for the selected one of the set of skills and at least one user trait level maintained for the user profile for the revised response input and the user interaction events.

12. The computer system of claim 2, wherein the computer system generates at least one confidence level for the user skill levels maintained for the user profile.

13. The computer system of claim 12, wherein the confidence level is at least partially based on the user interaction events.

14. A method for assessing skill proficiency and trait levels, comprising:
selecting, for presentation via a client application, one of a set of challenges stored in storage of a computer system and tagged with a selected one of a set of skills for which an identifier has been received by the computer system and an associated skill level, the one of the set of challenges being selected at least partially based on a user skill level maintained for a user profile;
receiving response input via the computer system for the one of the set of challenges;
tracking and registering user interaction events with the client application; and
updating the user skill level maintained for the user profile for the selected one of the set of skills and at least one user trait level maintained for the user profile for the response input and the user interaction events.

15. The method of claim 14, wherein updating of the at least one user trait level maintained for the user profile is performed via artificial intelligence.

16. The method of claim 14, further comprising generating a score for the response input for the one of the set of challenges for the user profile, and the user skill level for the selected one of the set of skills is adjusted at least partially based on the score for the response input.

17. The method of claim 15, further comprising registering the updated user skill level with previously registered user skill levels maintained for the user profile.

18. The method of claim 15, further comprising registering the at least one updated user trait level with previously registered user trait levels maintained for the user profile.

19. The method of claim 15, wherein the selected one of the set of challenges is tagged with another of the set of skills, the method further comprising updating of the user skill level maintained for the user profile for the other of the set of skills for the response input.

20. The method of claim 15, wherein the user interaction events comprise requests for assistance.

21. The method of claim 15, wherein the user interaction events comprise messaging events.

22. The method of claim 15, wherein the user interaction events comprise a loss of focus of the client application.

23. The method of claim 15, wherein the user interaction events comprise a presentation of the selected one of the set of challenges and the receipt of response input for the selected one of the set of challenges.

24. The method of claim 15, further comprising, upon receiving revised response input for the selected one of the set of challenges, updating the user skill level maintained for the user profile for the selected one of the set of skills and at least one user trait level maintained for the user profile for the revised response input and the user interaction events.

25. The method of claim 15, further comprising generating at least one confidence level for the user skill levels maintained for the user profile.

26. The method of claim 15, wherein the confidence level is at least partially based on the user interaction events.
